(19) United States
(12) Patent Application Publication
(10) Pub. No.: US 2016/0026241 A1
(43) Pub. Date: Jan. 28, 2016

(54) System and Method for Monitoring Habits of User of Electronic Device

(71) Applicant: Spencer Yu Cheong Leung, Hong Kong (CN)

(72) Inventor: Spencer Yu Cheong Leung, Hong Kong (CN)

(21) Appl. No.: 14/873,142

(22) Filed: Oct. 1, 2015

Related U.S. Application Data
(63) Continuation-in-part of application No. PCT/CN2014/080315, filed on Jun. 19, 2014.

(30) Foreign Application Priority Data
Jul. 18, 2013 (HK) 13108461.8

(51) Int. Cl. G06F 3/01

(52) U.S. Cl. CPC G06F 3/012

(57) ABSTRACT

The invention includes a method for monitoring habits user of electronic device. The method has steps of providing a presetting module for capturing and storing characteristics of the registered user in a presetting mode. The registered user characteristics including a) a first horizontal distance, the first horizontal distance being a first reference distance between two facial features of the registered user; b) a first vertical distance, the first vertical distance being a second reference distance between two facial features of the registered user; c) a second horizontal distance, the second horizontal being a third reference distance between two non-facial features of the registered body below the registered user's head, the two non-facial features capturable by the camera's view during use of the electronic device; and d) a second vertical distance, the second vertical distance being a fourth reference distance between the non-facial features and a facial feature of the registered user.

### CROSS-REFERENCE TO RELATED APPLICATIONS

This application is a continuation-in-part application claiming priority from International Application No. PCT/CN2014/080315 filed Jun. 19, 2014 (published as WO2015/007132A1) and Hong Kong Patent Application No. 13108461.8 filed Jul. 19, 2013, contents of which are incorporated in this application in their entirety.

### FIELD OF THE INVENTION

The present invention is concerned with a system and method for monitoring habits (including posture) of a registered user of an electronic device, and an electronic device including or otherwise making use of such system.

### BACKGROUND OF THE INVENTION

Smart devices including smart phones, tablets and netbooks have become very popular in the past decade. They have now become an indispensable element in many people's daily living. Statistics have indicated there is a trend that an average person has been spending more and more time using these devices on daily basis. For this reason, it is thus expected that the time spent on using these devices will only increase in the foreseeable future.

Despite the increasingly widespread use of such devices, there have been very few effective systems which address misuse of these devices. By misuse, it means a user may use the devices with poor habits, e.g. using for excessive duration of time and/or assuming improper posture during use of the devices. Misuse of these devices would lead to all sorts of problems including health and emotional problems.

FIG. 1 shows a user viewing the display of a tablet. Although the user is not bending her head downward, she is viewing the tablet display at an excessively close distance. Repeated or continuous tablet use in this manner would cause much strain to the eyes and eventually could lead to myopia or other eye defects. This is a poor habit that many people, especially children, tend to develop. For sake of clarification, it is envisaged that there are two imaginary planes, namely a vertical plan V and a horizontal plane H as represented by the two dotted lines in FIG. 1, respectively. When a user is looking forward without bending her neck or back forward or downward, her spine and neck is positioned in parallel with the vertical plane V. However, when the user, for example bending her head downward, the extent of bending can be represented by an angle t between the vertical plane V and a plane defined by the user's beck having bent downward.

Another poor habit that portable device users tend to develop is illustrated in FIG. 2. As shown in FIG. 2, the user views the display of the tablet by excessively bending her head downward. Prolonged excessive bending of the head exerts much stress and strain to the neck and would cause problems to the neck and spine including difference types of degenerative diseases. In some countries, this condition is sometimes addressed as the BlackBerry Neck.

The situation is made worse because the cost of many smart devices have come down considerably and many schools actually have switched to using e-books. As such, it has become very common for children to use smart devices as an electronic learning tool or even as a toy. With inadequate supervisor, many children have developed poor habits in using these devices as described above, and are slowly injured due to such use.

The present invention seeks to address the aforementioned problems, or at least to provide an alternative to the public.

### SUMMARY OF THE INVENTION

According to a first aspect of the present invention, there is provided a system for monitoring habits of a registered user of an electronic device, comprising steps of:—

a) a detection module configured to generate data for use in extrapolating posture characteristics of the registered user during regular use of the electronic device, the posture characteristics including viewing distance between the registered user and the electronic device, extent of bending of the registered user's head when viewing the electronic device, and duration of time that the registered user has been viewing the electronic device;
b) a calculation module configured to utilize the data collected from the detection module and to extrapolate a particular posture assumed by the registered user;
c) a comparison module configured to match the particular posture in step b) against a number of postures pre-determined as unacceptable postures and to generate an output instruction when a match is identified, information of the unacceptable postures being stored in the comparison module or elsewhere in the system; and
d) a warning module configured to, on receipt of the output instruction in step c), execute an alert action, the alert action either preset to the system or pre-selectable by the registered user or a guardian of the registered user.

Preferably, the system may comprise means for detecting angular position of the electronic device in relation to ground level. The detection means may be an accelerometer. The detection module may include a proximity sensor for detecting the viewing distance. The detection module may include a camera.

Advantageously, the posture characteristics may further include extent of bending the registered user's back when viewing the electronic device.

The system may comprise a presetting module for capturing and storing characteristics of the registered user in a presetting mode, the registered user characteristics including:—
a) a first horizontal distance, the first horizontal distance being a first reference distance between two facial features of the registered user;
b) a first vertical distance, the first vertical distance being a second reference distance between two facial features of the registered user;
c) a second horizontal distance, the second horizontal being a third reference distance between two non-facial features of the registered body below the registered user's head, the two non-facial features capturable by the camera's view during use of the electronic device; and
d) a second vertical distance, the second vertical distance being a fourth reference distance between the non-facial features and a facial feature of the registered user.
   The first reference distance may be a distance between the center of the right eye and the center of the left eye of the registered user. The second reference distance may be a distance between a center point between the right eye and the left eye of the registered user and the tip of the registered user's nose. The third reference distance may be a distance across a base of the neck of the registered user. The fourth reference distance may be a distance between the base of the neck and the lowest point of the registered user's chin.

In one embodiment, the detection module may be configured to, in an exercise of real-time detection, detect and capture characteristics of:—
a) a first recorded distance between the two facial features of the first reference distance;
b) a second recorded distance between the two facial features of the second reference distance;
c) a third recorded distance between the two non-facial features of the third reference feature;
d) a fourth recorded distance between the non-facial features of the third reference feature and the facial feature of the fourth reference distance; and/or
e) an angle of inclination of the electronic device.

The calculation module may be configured to conduct extrapolation, based on a) the stored characteristics of the registered user obtained from the presetting module and b) the captured characteristics of the registered user during real-time detection exercise, a particular posture assumed by the registered user in the real-time detection exercise.

The comparison module may be configured to, on receipt of data from the extrapolation indicative of the particular posture, determine whether during the real time detection:—
a) the viewing distance is shorter than a predetermined acceptable value;
b) the extent of bending of the head is greater than a predetermined acceptable value;
c) the extent of bending of the back of the user is greater than a predetermined acceptable value; and/or
d) the duration of time the electronic device has been in use for longer than a predetermined allowable duration.

The alert action may be configured to include, select or selectable from a group including prompting a visual message on a screen of the electronic device, prompting an audio signal via a speaker of the electronic device, generating a vibration to the electronic device and turning off the electronic device.

According to a second aspect of the present invention, there is provided a smart phone, a tablet or a computing device provided with a screen with which a user interacts, comprising a system as described above.

According to a third aspect of the present invention, there is provided a method for monitoring habits of a registered user during use of an electronic device, comprising at least some of:—
a) providing a detection module configured to generate data usable for use in extrapolating posture characteristics of the registered user during regular use of the electronic device, the posture characteristics including viewing distance between the registered user and the electronic device, extent of bending of the registered user's head when viewing the electronic device, and duration of time of the registered user viewing the electronic device;
b) providing a calculation module configured to utilize the data collected from the detection module and to extrapolate a particular posture assumed by the registered user;
c) providing a comparison module configured to match the particular posture in step b) against a number of postures predetermined as unacceptable postures and to generate an output instruction when a match is identified, information of the unacceptable postures being stored in the comparison module or elsewhere in the system; and
d) providing a warning module configured to, on receipt of the output instruction in step c), execute an alert action, the alert action is either preset to the system or pre-selectable by the registered user or a guardian of the registered user.

The method may comprise providing means for detecting angular position of the electronic device in relation to a ground level, wherein the detection means is a gyroscope and the detection module includes a camera.

The posture characteristics may further include extent of bending the registered user's back when viewing the electronic device.

The method may comprise providing a presetting module for capturing and storing characteristics of the registered user in a presetting mode, the registered user characteristics including:—
a) a first horizontal distance, the first horizontal distance being a first reference distance between two facial features of the registered user;
b) a first vertical distance, the first vertical distance being a second reference distance between two facial features of the registered user;
c) a second horizontal distance, the second horizontal being a third reference distance between two non-facial features of the registered body below the registered user's head, the two non-facial features capturable by the camera's view during use of the electronic device; and
d) a second vertical distance, the second vertical distance being a fourth reference distance between the non-facial features and a facial feature of the registered user.

### BRIEF DESCRIPTION OF DRAWINGS

Some embodiments of the present invention will now be explained, with reference to the accompanied drawings, in which:—

FIG. 1 is a schematic diagram illustrating a user using a conventional tablet in one posture, in which the viewing distance D between the face (or the eyes) of the user and the display of the tablet being too close;

FIG. 2 is a schematic diagram illustrating the user shown in FIG. 1 using the conventional device in a different posture, in which the user excessively bending her head downward when viewing the display of the tablet;

FIG. 3A is a flow chart showing logistics of an embodiment of a monitoring system in accordance with the present invention;

FIG. 3B is a flow chart showing logistics of a different embodiment of a monitoring system in accordance with the present invention;

FIG. 4 is a flow chart showing logistics of an illustration of a monitoring system in accordance with the present invention;

FIG. 5 is a flow chart showing detailed logistic of an illustration of a monitoring system of the present invention;

FIG. 6 is a flow chart showing exemplary logistics of monitoring duration of use of a tablet in accordance with the present invention;

FIG. 7 is a flow chart showing exemplary logistics of monitoring posture of a user by an accelerometer of the monitoring system in accordance of the present invention;

FIG. 8 and FIG. 9 are schematic diagrams showing two embodiments of processes, respectively, used in a monitoring system according to the present invention;

FIG. 10 is a schematic diagram showing an embodiment of a registration process of a monitoring system according to the present invention;

FIGS. 11-20 are schematic diagrams illustrating, in use, detection and extrapolation of the posture of a registered user of a smart device making use of the monitoring system of FIG. 10;

FIG. 21 is a graph showing exemplary relationship of i) actual viewing distance between user eyes and phone (x-axis) and ii) facial feature distance (y-axis); and

FIG. 22 is a graph showing exemplary relationship of i) angle of inclination between phone and ground (x-axis) and ii) facial feature distance (y-axis).

### DETAILED DESCRIPTION OF PREFERRED EMBODIMENTS OF THE INVENTION

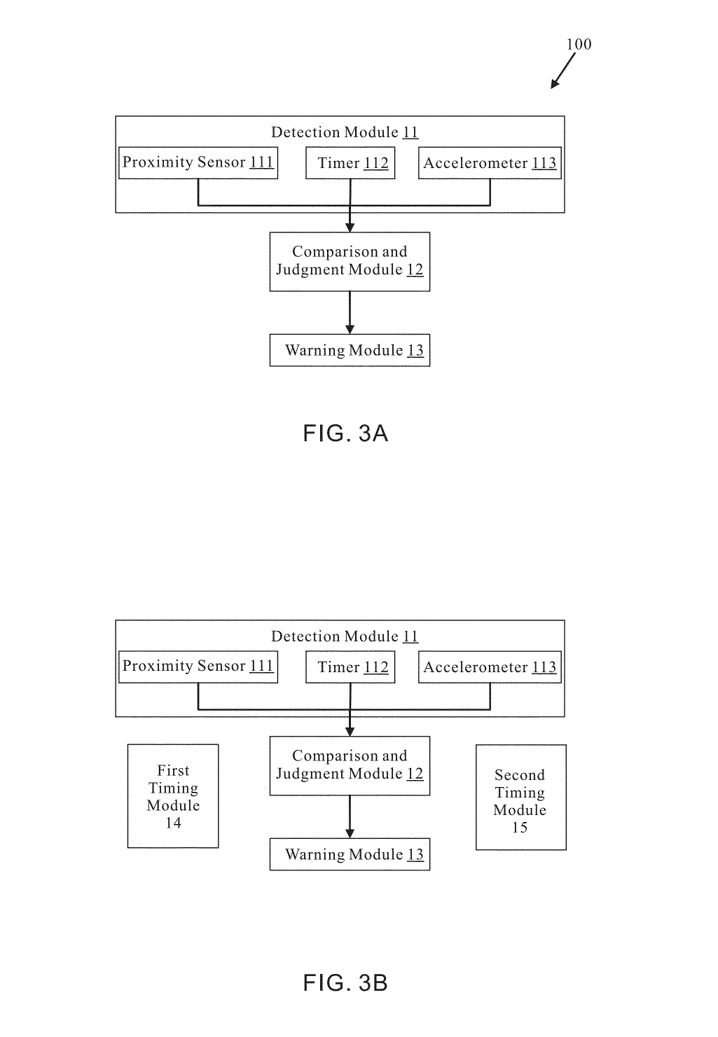

FIG. 3A is a flow chart which illustrates an embodiment of a smart device monitoring system. The monitoring system 100 comprises a detection module 11, a comparison and judgment module 12 and a warning module 13. The detection module 11 operates to detect at least one user characteristic representing how a user uses the smart device so that it is possible to ascertain, for example, the user's posture while s/he is using the smart device. The characteristics herein include but not limited to the distance between a user's face and the display of a smart device, the duration of time that the time of smart device has been used by or engaged with the user (i.e. serving time), and the angle of inclination of the smart device display with respect to the horizontal plane during use by the user. (The angle of inclination is indicative of at least how the user is holding on the smart device.) Data associated with the characteristics is then captured. The comparison and judgment module 12 connected with the detection module 11 is configured to ascertain whether any detected characteristic data exceeds a specified range or parameter defined by a respective predetermined threshold. It is to be noted that the predetermined thresholds of the characteristic data include but not limited to the thresholds for the viewing distance, the time duration of and the inclination angle of the smart device. The warning module 13 is configured to output an alert signal to the surroundings when at least one characteristic data exceeds the respective specified range. The alert signal may be selected from a group including a text message appearing on, for example, the smart device display, a graphic message, a sound, a change in illumination and a vibration. Further details are explained below.

In a specific application of this embodiment, the detection module 11 can further include a proximity sensor 111 for measuring the viewing distance, e.g. the distance between the user's face and the display of the smart device, a timer 112 for measuring the continuous serving time of the smart device, and an accelerometer 113 for measuring the angle of inclination between the smart device display and the horizontal plane. It is to be noted that the accelerometer can be replaced by a gyroscope capable of achieving the same function. As it can be understood, the distance, serving time and angle of inclination mentioned above contribute to the characteristic data which represents the conditions of use of the smart device by the user.

In use, when the smart device is switched on the proximity sensor 111, the timer 112 and the accelerometer 113 begin to take sample characteristic data. The comparison and judgment module 12 performs a comparison between the detected characteristic data and a group of predetermined thresholds. When the viewing distance between user's face and the display is below the distance threshold, or when the continuous serving time of the smart device is above the serving time threshold, or when the angle of inclination is below the inclination angle threshold, the warning module 13 outputs the alerting signal to remind the user to, for example, improve his/her posture.

As explained above, the alert signal can be a text signal, graphic signal, sound signal, light signal, vibration signal and a combination of thereof. For example, the system can be configured to display an alert text “Too close to the screen! Please view at a safe distance.”, “You have been using the smart device for too long!”, “Please take care of your eyes!”, or “Poor posture! Please pay attention to your neck posture!”. The system can also be configured to output graphic signals for the purpose of demonstrating that, for example, the viewing distance between the user's eyes and the display is too short, the continuous serving time is too long, and/or the angle of declination of eyesight is too large. The system can also be configured to output alerting sound message such as “Too close to the screen!”, “Please keep a rational distance!”, “You have been using the smart device for too long!”, “Please take care of your eyes!”, or “Poor posture! Please pay attention to the posture of your neck!”. The system can also be configured to alert the user by way of adjusting degree of illumination of the smart device display.

FIG. 3B is a flow chart showing another embodiment of a smart device monitoring system of the present invention. Compared with the embodiment of FIG. 3A, this monitoring system further comprises a first timing module 14 and a second timing module 15. These two timing modules are connected and work with the detection module 11, the comparison and judgment module 12 and the warning module 13. The monitoring system can achieve more effective and optimal control over the smart device by the arrangement of these two timing modules.

The first timing module 14 is configured to record an excess time when any one characteristic data exceeds the specified range defined by a respective predetermined threshold. The term “excess time” used herein refers to the duration of time that the collected characteristic data has exceeded the specified range defined by the predetermined threshold. For example, in the scenario in which a serving time threshold is 30 minutes, the first timing module 14 begins to record the excess time when the continuous serving time exceeds 30 minutes, and the recorded excess time is 15 minutes when the continuous serving time of 45 minutes has incurred.

During the excess time, the proximity sensor 111, the timer 112 and the accelerometer 113 continue to take a sample. If it is detected that the user's posture has not been improved, the warning module will send out a lengthened or enhanced alert signal at a preset frequency so as to remind the user to improve the posture. For instance, such alerting signal is sent out every 2 minutes when the user refuses to improve his/her posture. Specific frequency is not limited to any specific example indicated herein, because it can be pre-set as required. Moreover, two models may be adopted to enhance the alert signal. In a first model, all of the enhanced or lengthened alert signals have the same strength and duration, which means all the alert signals are enhanced or lengthened in the same extent. In a second model, the enhanced or lengthened alert signals have increased strength and duration when compared with that of the first model so that the alerting effect can be enhanced.

When the excess time reaches its predetermined limit and the detected user's posture still has not improved, the warning module can be configured to switch off the display of the smart device. It can be understood that the predetermined limit for excess time is also a pre-settable parameter of the monitoring system, which means its specific value can be designed according to the control demand on the smart device. Through the cooperation between the first timing module 14 and any other modules, the monitoring system can enhance the alerting effect and force to switch off the display when the user ignores the alerting signal.

In the event that the smart device is equipped with a magnetic switch to control its display, the monitoring system can operate on an electromagnet to realize the above-mentioned switch-off function. That is, the magnetic switch is controlled through the electromagnet so that the display of smart device is temporally switched off. In another application, the switch-off function can be realized by interrupting the operation of the smart device. In this case, the smart device is forced to enter a standby mode or a sleep mode by the monitoring system.

When the display is switched off by the user or is forced to be switched off, the monitoring system is however not terminated immediately. Instead, the second timing module 15 is initiated to record the time duration during the switch off of the smart device. When the switch-off duration reaches its predetermined value, the entire monitoring system is reset to clear the detected characteristic data and the recorded excess time. The smart device is re-initiated when its display is switched on next time. To the contrary, if the smart device is switched back on immediately by the user (i.e. when the switch-off time duration is smaller than its predetermined value), it remains to be monitored on the basis of the previously detected characteristic data and the recorded excess time.

Although it is not specifically illustrated in the two embodiments above, a skilled person in the art would envisage that the monitoring system is equipped with a processor for coordinating the communication and operation of the respective module. The processor can be adapted to switch off the display against will of the smart device user. The monitoring systems in the above illustrated embodiments can be installed within the smart device. Nevertheless, they can also be an external attachment to the smart device. When the monitoring system is installed to the smart device externally, it can for example be connected with the smart device through an input/output interface.

It is to be noted that, for the purpose of avoiding any detection error, once it is ascertained that any characteristic data exceeds the specified range, the detection module 11 will re-detect the corresponding characteristic data, and then the comparison and judgment module will perform a comparison on at least two detection results. If the deviation between the results is too large (e.g. above 5% or 10%), it means the previous detections may be erroneous due to an unforeseen circumstances, and the warning module 13 as a result is prevented from sending out false alerting signals.

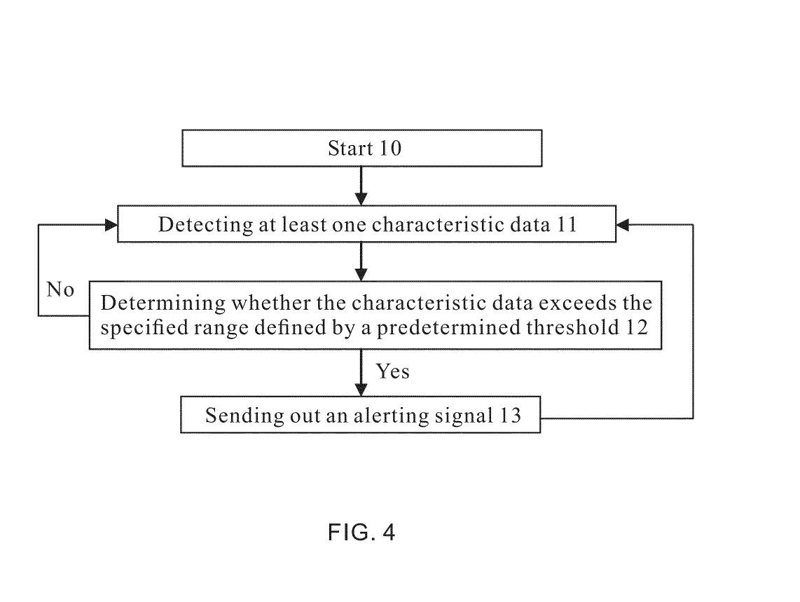

FIG. 4 is a flow chart illustrating an embodiment of a smart device monitoring method in accordance with the present invention. This method begins with step 10. After the method begins, at step 11 at least one characteristic data is detected to ascertain how a user uses the smart device. This characteristic data includes the viewing distance between the user's face and the display of the smart device, the continuous serving time of the smart device and the angle of inclination between the smart device display and the horizontal plane. At step 12, it is ascertained as to whether any one characteristic data has exceeded the specified range defined by a respective predetermined threshold. At step 13, an alert signal is output to the surroundings when at least one characteristic data has exceeded the respective specified range defined by the respective predetermined threshold.

After the step 13 has completed, the method is repeated in that it continues to monitor how the user is using the smart device, i.e. to ascertain the user's posture, etc. If the user's posture has improved such that the or all characteristic data is within the preset specified range or ranges, a new monitoring task or operation will be conducted on the smart device by re-detecting the characteristic data. However, if the user still maintains the previous (undesirable) posture or if the user has used the smart device for a time duration exceeding the pre-set time duration, enhanced alert signals will be output to the surroundings at a preset frequency. If during the time when the user has exceeded the pre-set time in using the smart device, as long as the user's posture has improved a new monitoring task will then be carried out on the smart device. However, the smart device display is caused to switch off when the excess time has reached its predetermined maximum limit. In such scenario, the time duration of the switch-off is recorded. When the switch-off time duration has expired, a new monitoring task is carried out on the smart device after all the detected and recorded data has been purged. However, if the smart device is switched back on immediately by the user before the pre-set switch-off time duration has expired, the monitoring task resumes on the basis of the previously detected characteristic data and the recorded excess time.

More specific embodiments of a monitoring system according to the present invention are now explained as follows.

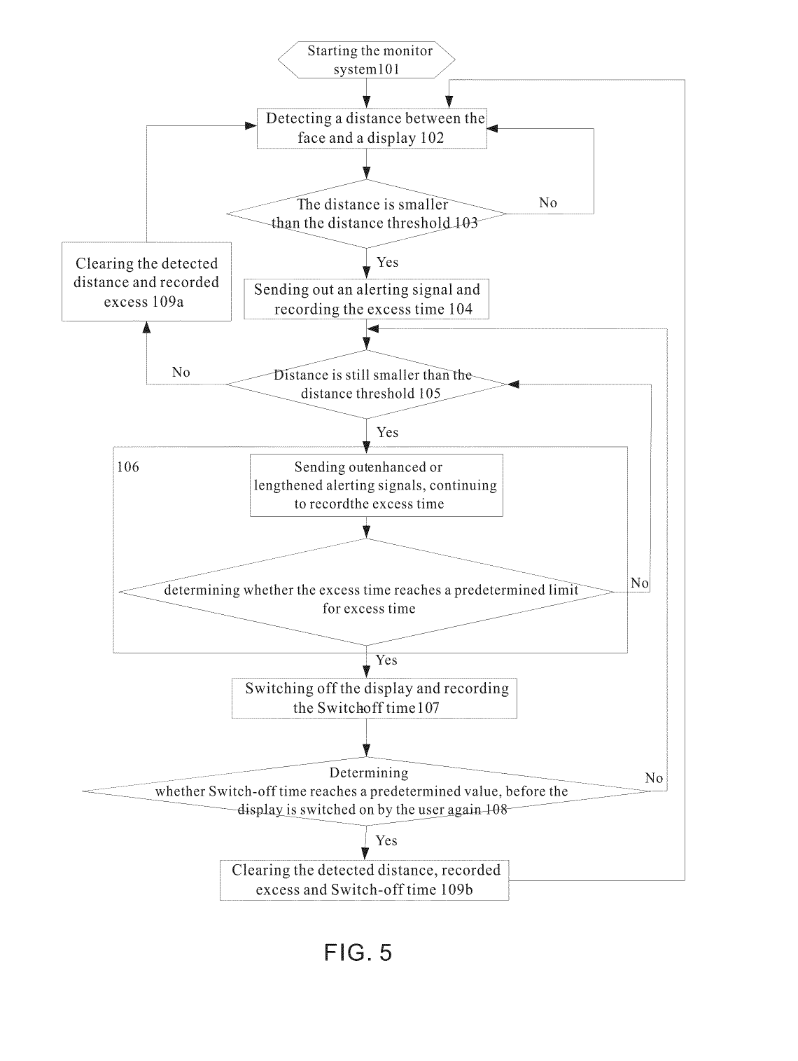

FIG. 5 is a flow chart illustrating a process for monitoring the viewing distance between a user and the display of a smart device.

At step 101, the smart device user monitoring system is initiated.
At step 102, the viewing distance between the user's face and the smart device display is detected in real time or at a certain time interval. It is however preferable that the distance is detected continuously.
At step 103, the method seeks to ascertain whether the detected distance is smaller than a distance threshold. The distance threshold refers to a minimum requirement or preferably an optimal viewing distance between the user's face and the smart device display. For example, it may be 30 cm. If the detected distance meets this requirement, the method loops back to step 102 for the next viewing distance detection. In other words, the method can continue detection of the viewing distance repeatedly.
At step 104, if the detected distance is smaller than the distance threshold, e.g. 30 cm, the system will send out an alert signal and warn the user to pay attention to the viewing distance. Meanwhile, the time duration in which the smart device is used under the condition when the above-mentioned viewing distance is smaller than the distance threshold is recorded.
At step 105, the method determines whether the viewing distance at that point in time (i.e. real time viewing distance) between the user's face and the smart device display is still smaller than the distance threshold.
At step 106, if the detected viewing distance is still smaller than the corresponding threshold, a lengthened or enhanced alert signal is output by the system in order to increase the alerting effect. Meanwhile, the excess time continues to be recorded. It is then further determined whether the excess time has reached its predetermined limit. If not, the method will repeat step 105. If the excess time has reached its predetermined limit, the method proceeds to the next step 107.
At step 107, the smart device display is caused to be switched off. This is because the user had disregarded all warning messages and had continued to, for example, adopt poor posture. In this step, the time duration in which the display is switched off is recorded by the smart device.
At step 108, the method determines whether the time duration of the switch off has reached its predetermined value before the display can be switched back on by the user. If so, the method proceeds to step 109b and then step 102. Otherwise, the method proceeds to step 105 based on the characteristic data and the excess time obtained before switching off the display.
At step 109a, the characteristic data and the excess time data are cleared and the smart device returns to its normal function, i.e. the display resumes. The method proceeds to step 102.
At step 109b, the characteristic data, the excess time data and the switch-off duration of time data are cleared. When the smart device is switched on next time, the method begins at step 102.

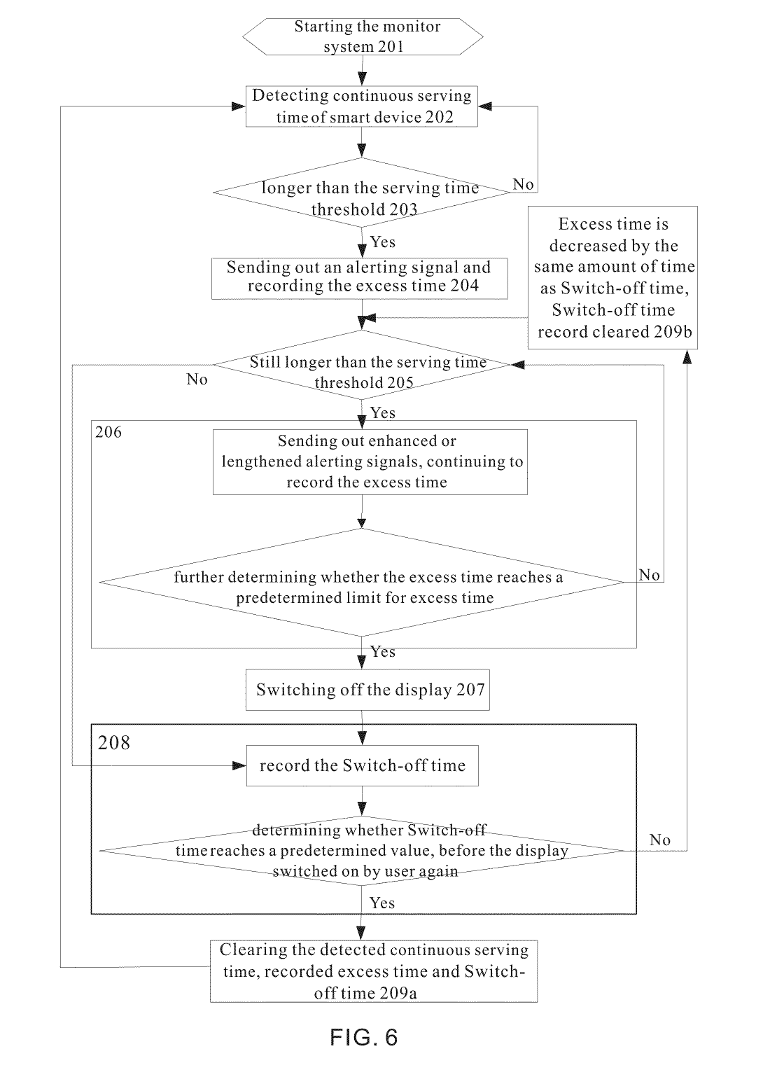

FIG. 6 is a flow chart illustrating a monitoring system in which the duration of continuous serving time of the smart device is addressed.

At step 201, the monitoring system of the smart device is initiated.
At step 202, the continuous serving time of the smart device is monitored either periodically or at regular interval
At step 203, it is ascertained whether the continuous serving time is longer than the respective predetermined threshold of allowable serving time. If the continuous serving time has not exceeded the threshold, the method will return to step 202. Otherwise, the method proceeds to step 204.
At step 204, the system output an alert signal. The purpose of the alert signal is to warn that the user of the smart device has been used continuously for too long time and remind the user to have rest from using the smart device. While the alert signal has been output, the excess time when the continuous serving time is longer than the serving time threshold is recorded.
At step 205, the method continues to detect the continuous serving time and then ascertain whether the continuous serving time is still longer than the serving time threshold.
At step 206, if the detected serving time is still longer than the allowable serving time threshold then an enhanced or lengthened alert signal is output by the system for the purpose of providing a more series alerting effect. Meanwhile, the method continues to record the excess time of usage, and then determines whether the excess time has reached its predetermined allowable limit. If not, the method will return to step 205 in which the detection process is continued and the excess time continues to be recorded. Otherwise, the method proceeds to the next step 207.
At step 207, if the allowable limit has been reached or exceeded the display is caused to be switched off so that the user is on longer possible to use the device.
At step 208, the system records the duration of time in which the smart device is switched off. Then, it seeks to ascertain whether the time duration of the switch-off has reached a predetermined value before allowing the display to be switched on by the user. If so, the method proceeds to step 209a and then step 202. Otherwise, the method proceeds to step 209b.
At step 209a, the characteristic data, the excess time data and the data of duration of time of the switch-off are purged such that the smart device returns to an initial stage and can function normally. In other words, it turns to step 202.
At step 209b, excess time is decreased by the same amount of time as switch-off time, Switch-off time record is cleared, and the method proceeds to step 205.

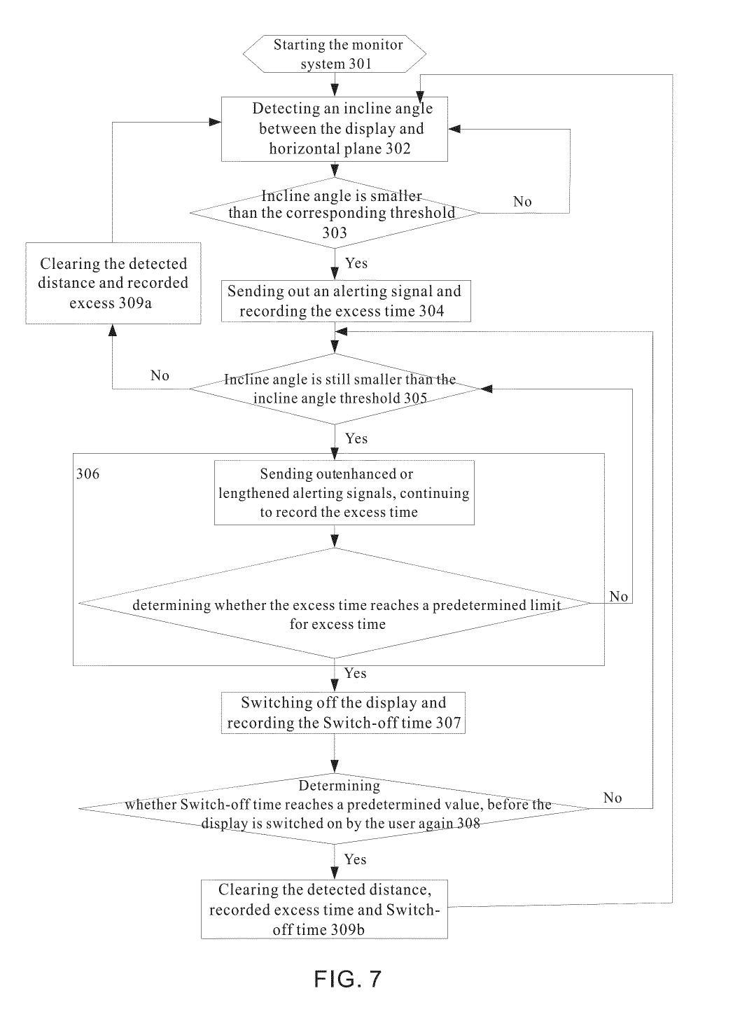

FIG. 7 illustrates an embodiment of a monitoring system in which the operating posture of the user of a smart device is addressed. In this embodiment, a method of the system is used to ascertain the operating posture of the user via assessing the angle of inclination of the display of the smart device with the horizontal plane.

At step 301, the monitoring system for smart device is initiated.
At step 302, the angle of inclination between the display of the smart device and the horizontal plane is detected. It is to be noted that this angle is indicative of how the smart device is held by the user in use, and also indicative of the user's posture when using the smart device.
At step 303, it is ascertained whether the detected angle of inclination is smaller than the predetermined threshold of allowable angle of inclination. If so, the method proceeds to step 304. Otherwise, the method will return to step 302 and perform detection of the angle of inclination again.
At step 304, the system outputs an alert signal to indicate that the posture by which the user has assumed in holding the smart device is incorrect. If the smart device is held at an excessively low position and the caused is caused to view the display of the smart device by excessively bending his/her down, much stress and strain is caused to the neck and neck pain is thus easily caused. In this scenario, the user is warned to pay attention to improve his/her posture in holding the smart device. Meanwhile, the excess time when such undesirable angle of inclination is recorded.
At step 305, the detection of the angle of inclination performed again and it is ascertained whether this angle of inclination is smaller than the threshold of allowable angle of inclination. If so, the method proceeds to step 306. Otherwise, the method proceeds to step 309a.
At step 306, an enhanced or lengthened alert signal is output by the system so as to increase the alerting effect, when the excess time continues to be recorded. Then, it is ascertained whether the excess time has reached its predetermined limit. If not, the method will return to step 305 in which the detection of the angle of inclination continues and the duration of the excess time is recorded. Otherwise, the method proceeds to the next step 307.
At step 307, the display is caused to be switched off in order to termination possible use of the smart device by the user. The switch off is caused by improper posture of use by the user despite the alerting signals. The duration of time of the switch off is recorded.
At step 308, it is ascertained whether the time duration of the switch-off has reached its predetermined value or expired before allowing the user to switch it on again. If so, the method proceeds to step 309b. Otherwise, the method proceeds to step 305.
At step 309a, the characteristic data and the excess time data are cleared, and the smart device returns to the initial stage at step 302.
At step 309b, after clearing the characteristic data, the excess time data, and the switch-off time data, the method returns to step 302 when the smart device is switched on next time.

For the purpose of avoiding detection errors, at steps 102, 105, 202, 205, 302 and 305 once it is ascertained that any characteristic data has exceeded a specified allowable range, the corresponding characteristic data will be re-detected and a comparison is made for the two detection results. If the deviation between the two is larger the predetermined allowable value, (e.g. above 5% or 10%), it means the previous detections may be wrong due to an unforeseen issue and as a result no alert signal would be output.

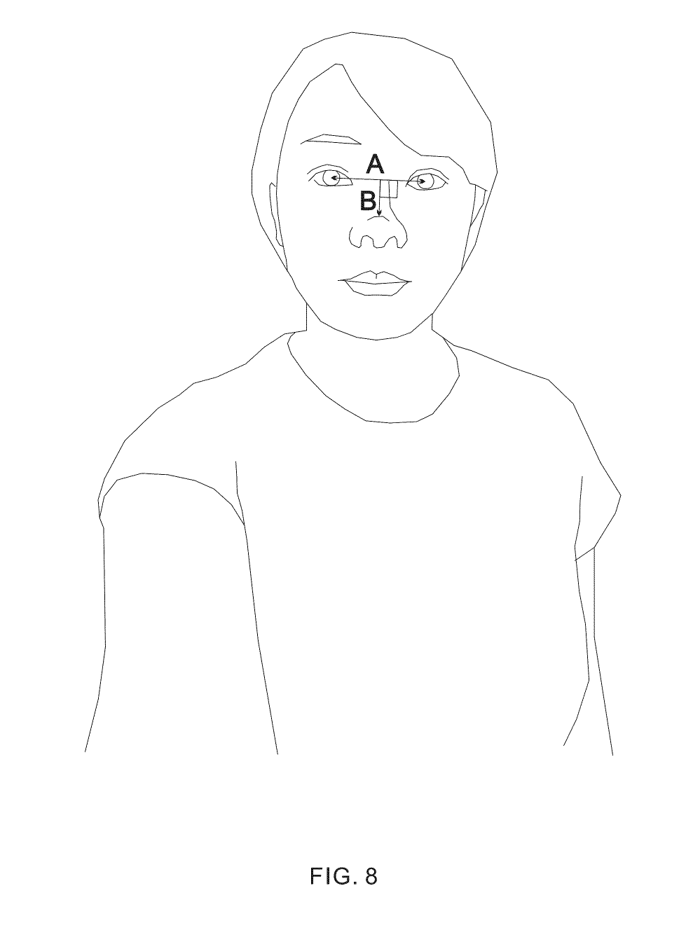

In an embodiment of a monitoring system of the present invention, during user registration with the system at least three characteristics are to be ascertained and respective data thereof is stored in the smart device of the monitoring system. During the registration, the user is instructed to look forward without the head bending down at all and to hold the smart device in front of himself/herself at eye level. FIG. 8 shows an image capturable by the camera of a smart device in a first step during the user registration process. In this first step, the distance between the centers of the left eye and the center of the right eye (pupils) in the image is to be ascertained and stored. This distance is designated “A” in FIG. 8. This distance is registered as a first reference distance. Then in an actual monitoring exercise, the distance between the centers of the left and right eyes in the real time image is to be ascertained again. This distance is a real time distance A detected in use. It can be envisaged that if the real time distance A detected in use is larger than the reference distance A, it is indicative that the user is holding the smart device closer (or too close) to himself/herself. If the real time distance A detected in use is smaller than the reference distance A, it is indicative that the user is holding the smart device farther away from himself/herself. If the real time distance A detected in use is the same as the reference distance A, it is indicative that the user is holding the smart device at a distance identical to that when the registration was conducted.

In a second step, a center point is imputed between the centers of the eyes and the distance between this imputed center point and the tip of the nose is to be ascertained and stored. This distance is designated “B” in FIG. 8. This distance is registered as a second reference distance. In the actual monitoring exercise, the distance between the imputed center point and the tip of the nose in the real time image is to be ascertained again. This distance is a real time distance B detected in use. It can be envisaged that if the real time distance B detected in use is smaller than the reference distance B, it is indicative that the user may be holding the smart device below his/her eye level. If the real time distance B detected in use is larger than the reference distance B, it is indicative that the user may be holding the smart device above his/her eye level. If the real time distance detected in use is the same as the reference distance B, it is indicative that the user may be holding the smart device at his/her eye level.

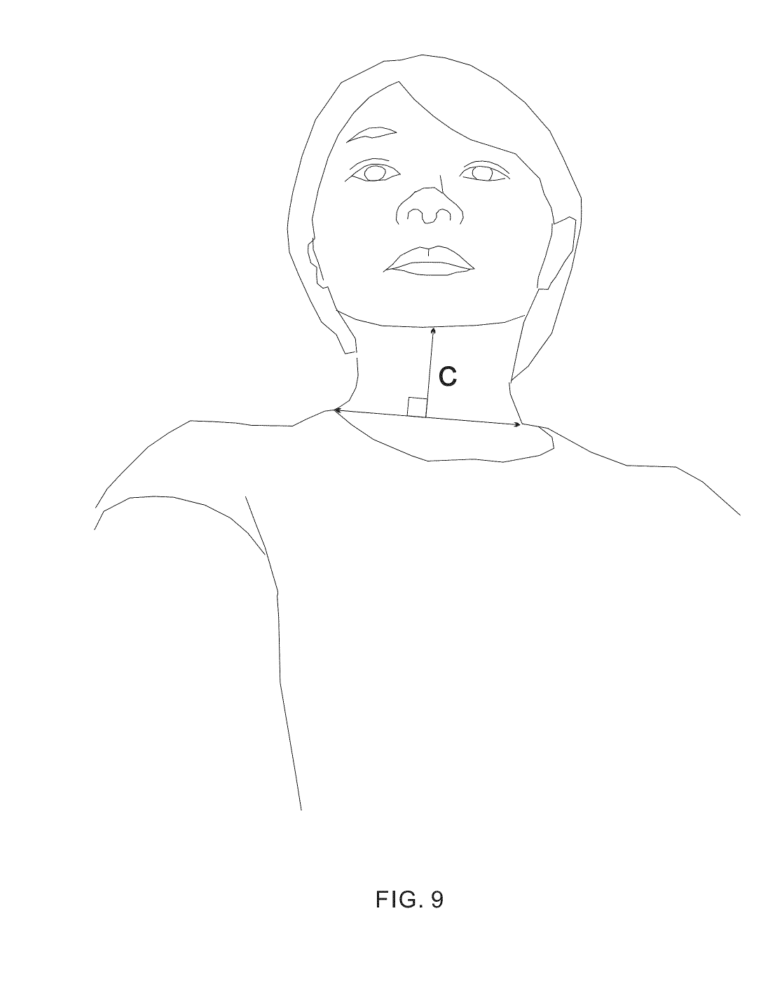

In a third step, the horizontal distance across the base of the neck of the user is firstly ascertained. This horizontal distance is a base line of the neck. Then the perpendicular distance between the bottom of the chin and the horizontal distance is ascertained and stored. This distance is designated “C” in FIG. 9. This distance is registered as a third reference distance. Then in the actual monitoring exercise, the real time perpendicular distance is ascertained again. This distance is a real time distance C detected in use. It is however to be noted that unlike distances A and B, distance C can have a negative value. Characteristics of distance C are explained below.

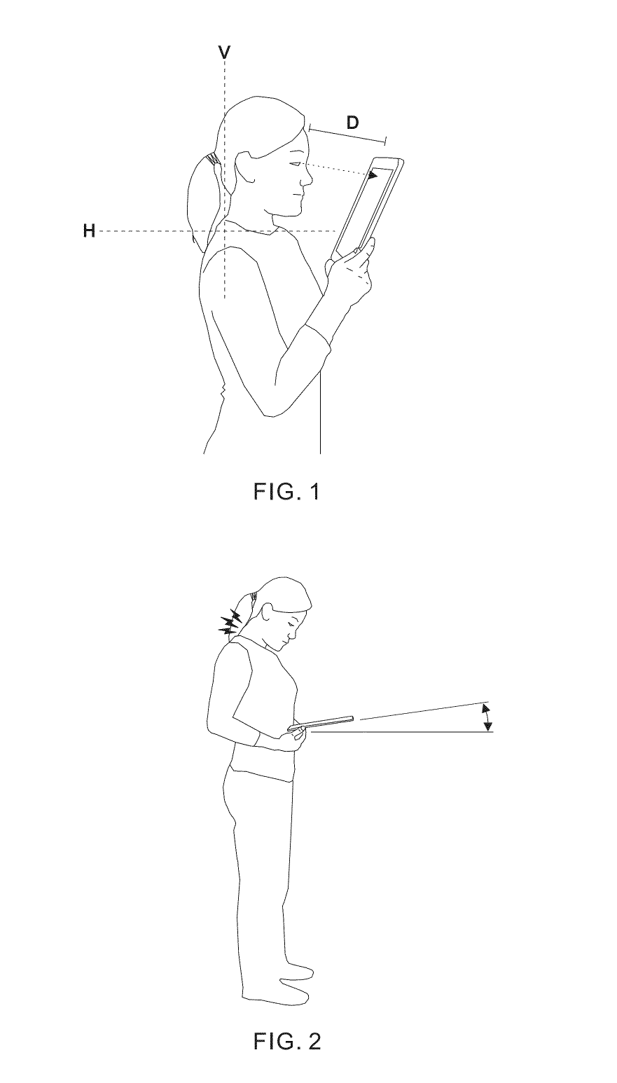

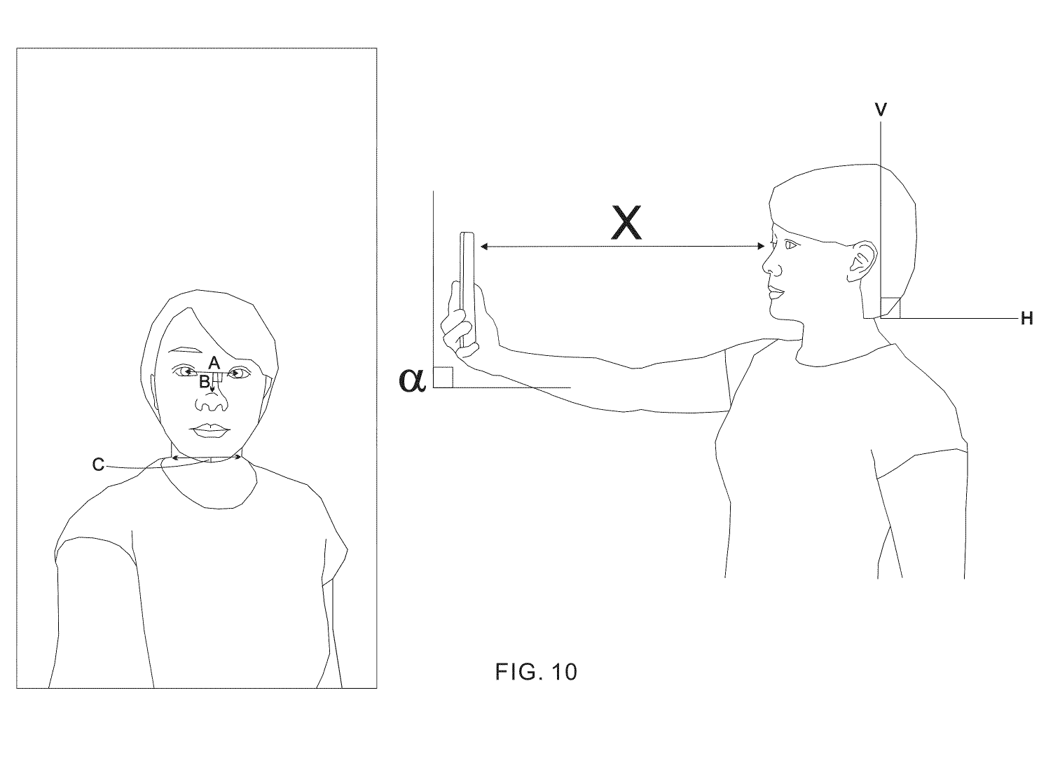

FIG. 10 further illustrates the registration process. Left portion in FIG. 10 is an image captured during the registration process from which the characteristics data is extracted. Right portion of FIG. 10 shows the posture assumed by the user during the registration process. It is shown that the user is instructed to look straight forward keeping her head level without bending the head downward or upward. In this posture, her neck and spine are not bending downward. In other words, her neck and spine define a vertical plane V as illustrated in FIG. 1. The extent of bending can thus be represented by angle t=0. She is directed to hold the smart device with one hand and extend her arm straight such that the smart device is at her eye level. The smart device is upstanding and vertically positioned. She is also directed to input data of the length of her arm, i.e. X, during the registration process. During the registration process, various characteristics including reference distances A, B, C, length of arm X and extent of bending of head, i.e. α=90°, are recorded.

Referring to the left portion of FIG. 10, it can be seen that the bottom of the chin is below the base line of the neck. When this occurs, distance C has a negative value. It is envisaged that if the registered user has a longer chin such that the chin extended much further below the base line, the reference distance C would have a larger negative value. On the other hand, if the registered user has a shorter chin such that the bottom of the chin does both go beyond or below the base line, the reference distance C would have a positive value.

After the registration process, data of the characteristics are stored in a presetting module.

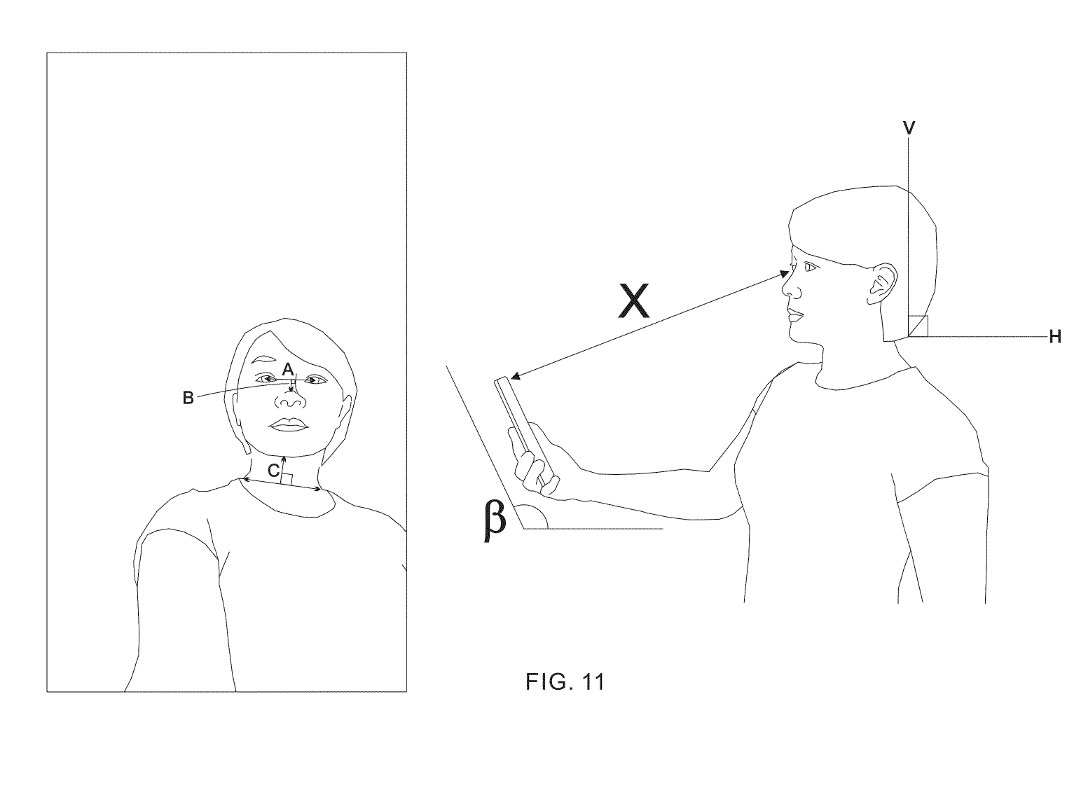

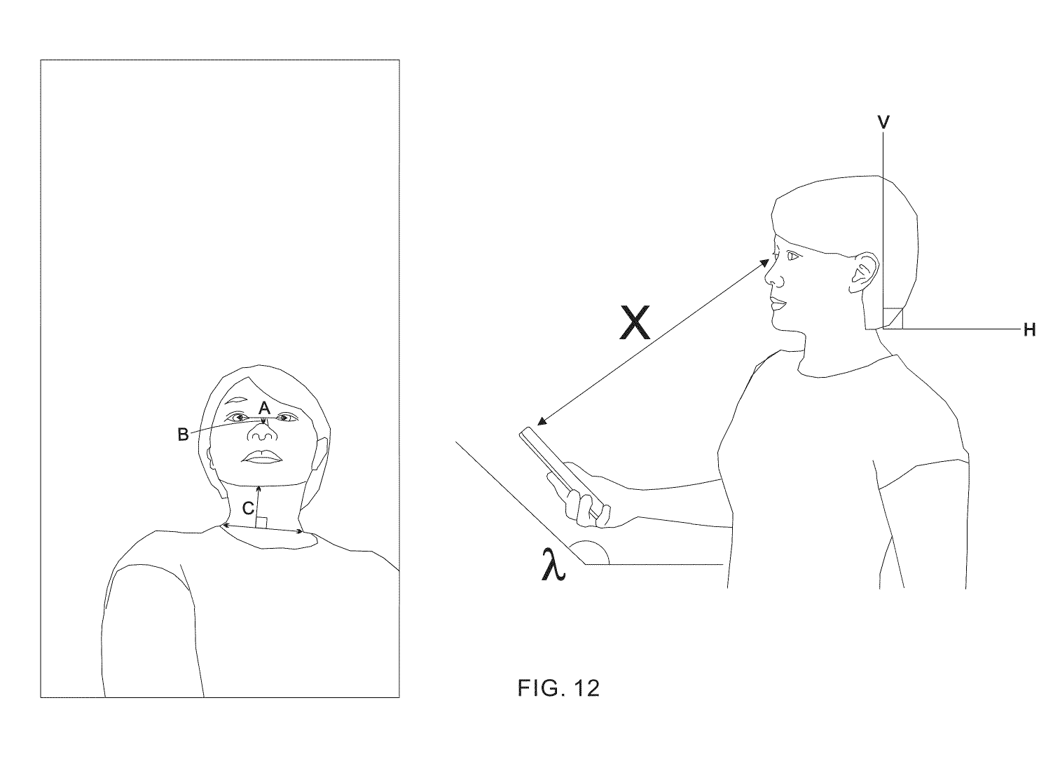

In a scenario in which the registered has a long chin such that the bottom of the chin extends below the base line, it can be envisaged that if the real time distance C detected in use increases from a negative value to zero or even a positive value, it may be indicative that the user holding the smart device at a lower elevation. Please see for example FIG. 11 or FIG. 12.

FIG. 11 illustrates an exemplary real time detection by a detection module of the monitoring system. Left portion of FIG. 11 is an image captured during the detection. Right portion of FIG. 11 shows the posture assumed by the user during the registration process. Although compared with the posture of FIG. 10 the (real time) distance A detected does not change, the (real time) distance B detected has changed and shortened due the user holding the smart device below her eye level. The extent of tilting of the smart device, or angle of inclination R, is detectable by a built-in accelerometer of the smart device. By comparing the real time distance A with the reference distance A, the real time distance B and the reference distance B, and taking the value of β into consideration, a calculation module of the monitoring system can utilize the real time data and the previously recorded data to extrapolate the particular real time posture assumed the user.

A comparison module of the monitoring system is that configured to ascertain whether the real time posture, when compared with the acceptable reference posture is maintaining acceptable posture, e.g. without excessively bending her head downward or viewing the display of the smart device as an unacceptably close distance. In this exemplary illustration, the increase of value of the real time distance C can be indicative that the smart device is positioned below the eye level. Please see FIG. 11 with reference to FIG. 10.

FIG. 22 assists the understanding of the exemplary scenario of FIG. 11. It is shown that as the angle of inclination of the phone increases, i.e. the phone is positioned form a vertical position to a more tilted position in relation to the user's face, the real time distance A in the captured image remains generally the same although the real time distance B in the captured image decreases.

FIG. 12 illustrates another exemplary real time detection by the monitoring system. Left portion of FIG. 12 is an image captured during the detection. Right portion of FIG. 12 shows the posture assumed by the user during the real time detection. FIG. 12 is generally similar to FIG. 11 in that the detected real time distance A is the same as the registered reference distance A, although the detected angle of inclination of the smart device is now larger than β in FIG. 11 (and a in FIG. 10). This allows the monitoring system to ascertain that the user is maintaining acceptable posture without excessively bending her head downward or viewing the display of the smart device as an unacceptably close distance. It is to be noted that compared to the scenario in FIG. 11, the value of C increases further.

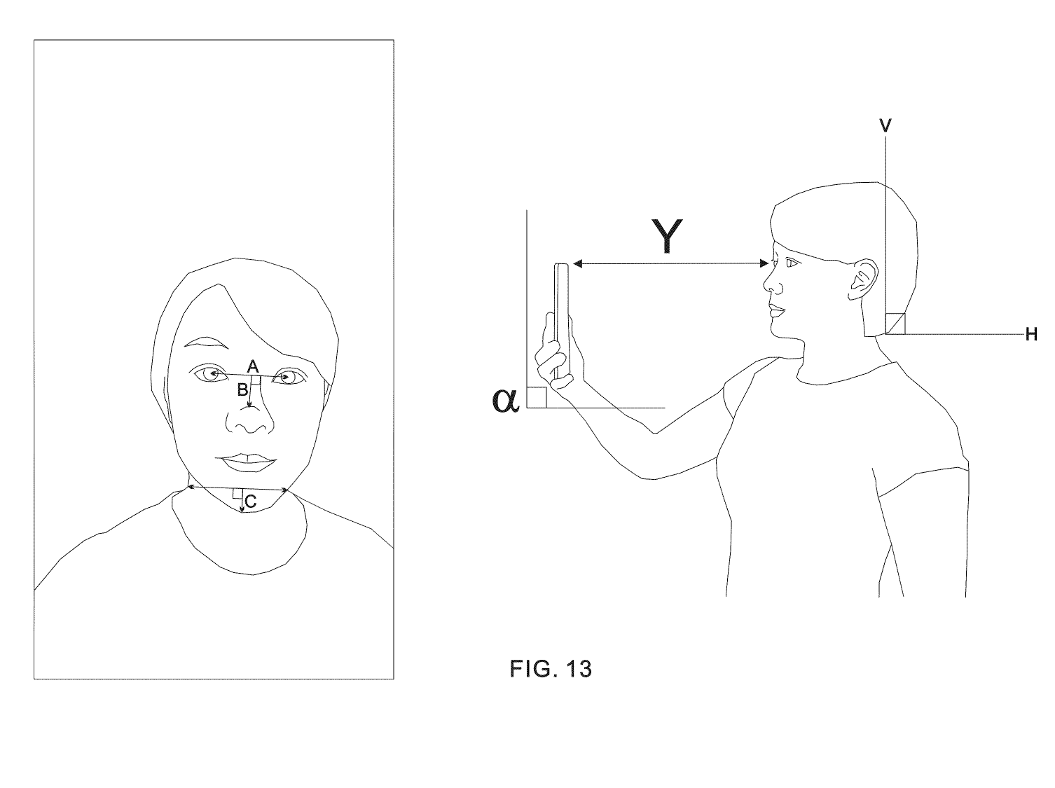

FIG. 13 illustrates another exemplary real time detection by the monitoring system. Left portion of FIG. 13 is an image captured during the detection. Right portion of FIG. 13 shows the posture assumed by the user during the real time detection. The scenario of FIG. 13 is most understandable with reference to that of FIG. 10. Although compared with the recorded reference the real time angle of inclination α has not changed, the distance A and the distance B as detected in the real time image have both changed (and increased). These together allow the monitoring system to ascertain that the user is viewing or at least holding the smart device a closer distance or an excessively close distance Y (Y<X). Depending the ratio of reference distance A and real time distance A, the value of Y can be ascertained. It is to be noted that compared to the scenario in FIG. 10, the negative value of C has further increased (i.e. in the image the chin extends further below the base line) despite the elevation of the smart device remains the same.

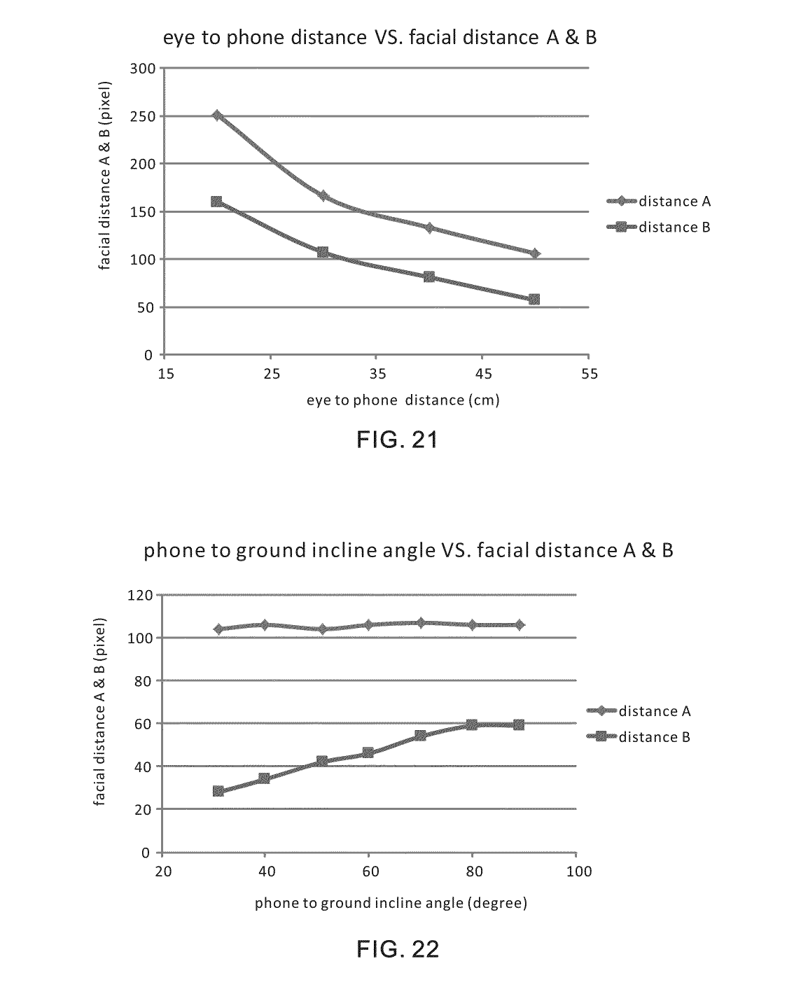

FIG. 21 assists the understanding of the exemplary scenario of FIG. 13. It is shown that as the viewing distance decreases, i.e. the phone moves closer to the user's face, the distance between pre-determined facial features (e.g. real time distances A, B) decreases.

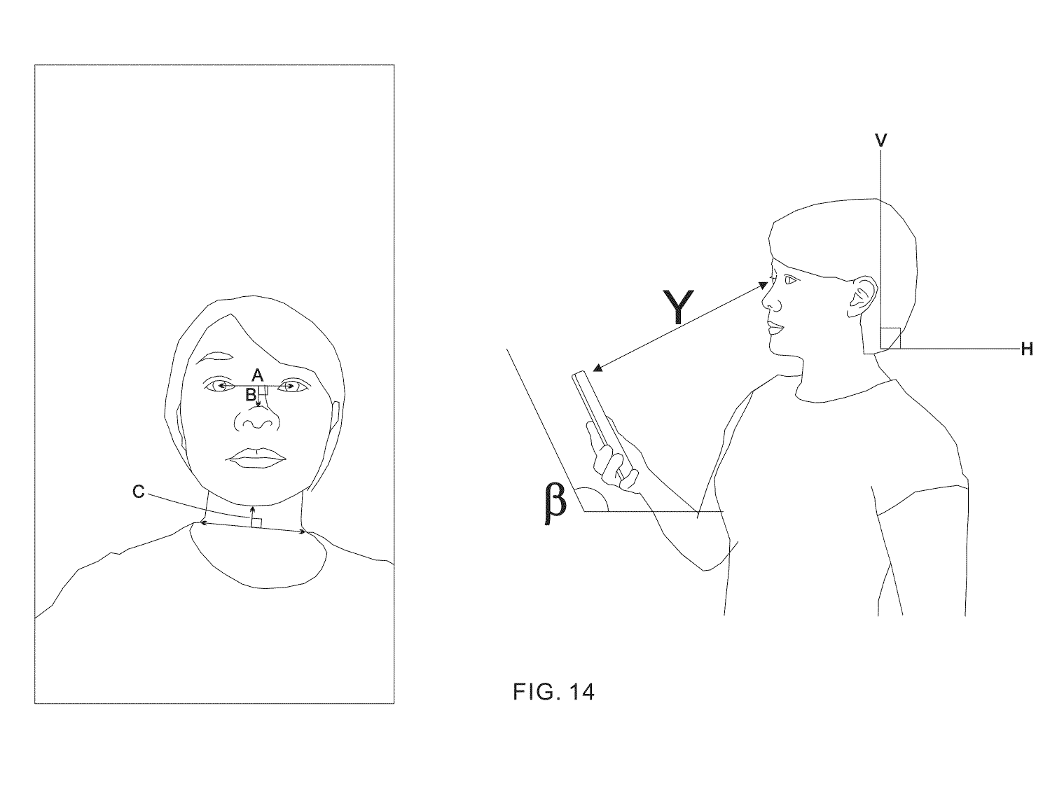

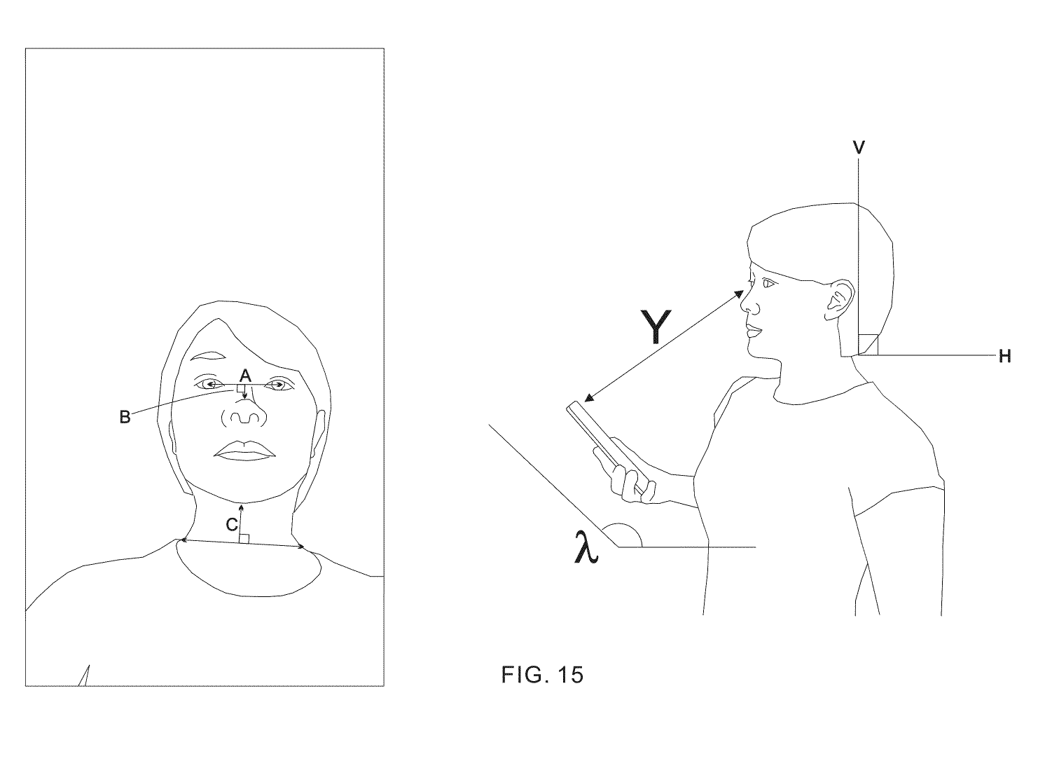

FIG. 14 illustrates another exemplary real time detection by the monitoring system (and is to be understood with reference to FIG. 13). Left portion of FIG. 14 is an image captured during the detection. Right portion of FIG. 14 shows the posture assumed by the user during the real time detection. The scenario of FIG. 14 is most understandable with reference to that of FIG. 10 and FIG. 13. The distance A detected in the real time image is larger than the reference distance A recorded. The distance B detected in the real time image is smaller than the reference distance B recorded. The angle of inclination β is larger than a. These together allow the monitoring system to ascertain that the user is viewing or at least holding the smart device an excessively close distance Y (Y<X) and lower her eye level. It is to be noted that compared to the scenario in FIG. 11, the value of C has become positive from negative, i.e. in the image the bottom of the chin stays above the base line.

FIG. 15 illustrates another exemplary detection by the monitoring system. Left portion of FIG. 15 is an image captured during the detection. Right portion of FIG. 15 shows the posture assumed by the user during the real time detection. The scenario of FIG. 15 is most understandable with reference to that of FIG. 10 and FIG. 14. However, the distance B detected in the real time image is even smaller than the distance B detected in the example of FIG. 14, and the angle of inclination of the smart device A is even larger than that in FIG. 14. It is to be noted that compared to the scenario in FIG. 14, the positive value of C has become even greater, indicative of the smart device is positioned even further below the eye level.

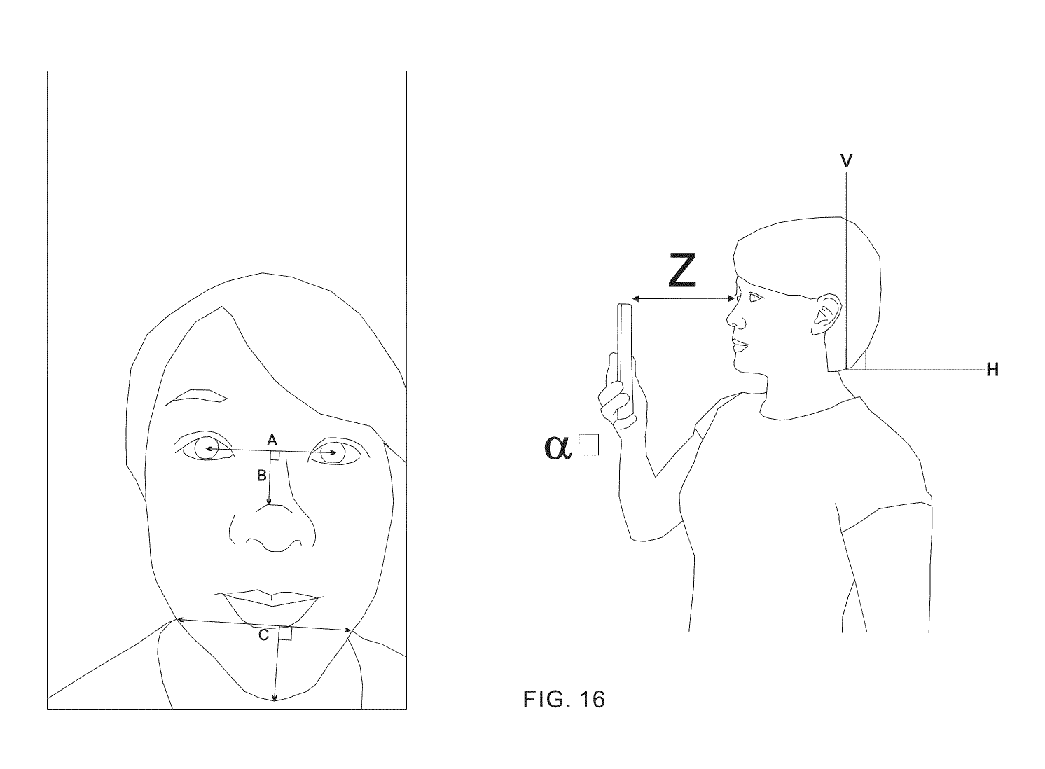

FIG. 16 illustrates another exemplary detection by the monitoring system. Left portion of FIG. 16 is a real time image captured during the detection. Right portion of FIG. 16 shows the posture assumed by the user during the real time detection. The scenario of FIG. 16 is most understandable with reference to that of FIG. 10 and FIG. 13. Compared with the posture shown in FIG. 13, the distance A and the distance B detected in the real time image are even larger than that of FIG. 13. This means the user is holding is viewing or at least holding the smart device an excessively close and unacceptable distance Z (Z<Y<X). It is to be noted that compared to the scenario in FIG. 13, the value of C has decreased further, indicative of the bottom of the chin extending further below the base line in the image.

FIG. 21 similarly assists the understanding of the exemplary scenario of FIG. 16. It is shown that as the viewing distance decreases, i.e. the phone moves closer to the user's face, the distance between pre-determined facial features (e.g. real time distances A, B) decreases.

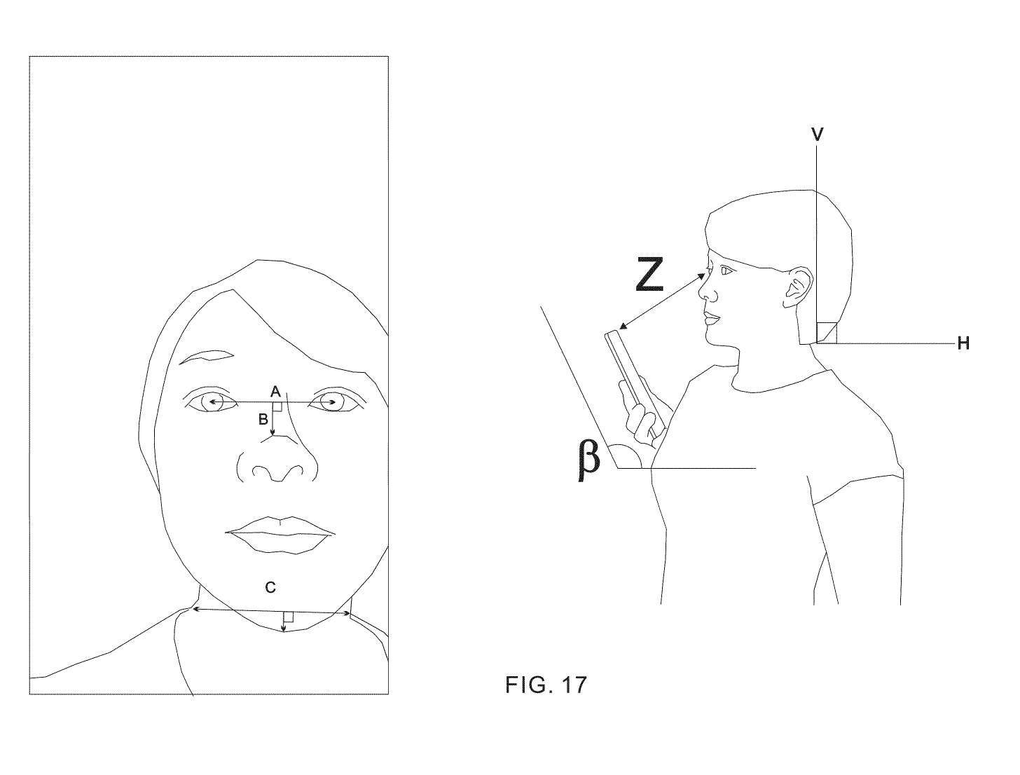

FIG. 17 illustrates another exemplary detection by the monitoring system. Left portion of FIG. 17 is a real time image captured during the detection. Right portion of FIG. 17 shows the posture assumed by the user during the real time detection. The scenario of FIG. 17 is most understandable with reference to that of FIG. 10 and FIG. 16. Compared to the posture assumed by the user in FIG. 16, the angle of inclination β of the smart device detected is larger than that of FIG. 16, i.e. β>α. The detected characteristics together indicates that the smart device is positioned below the eye level and at a close distance to the user.

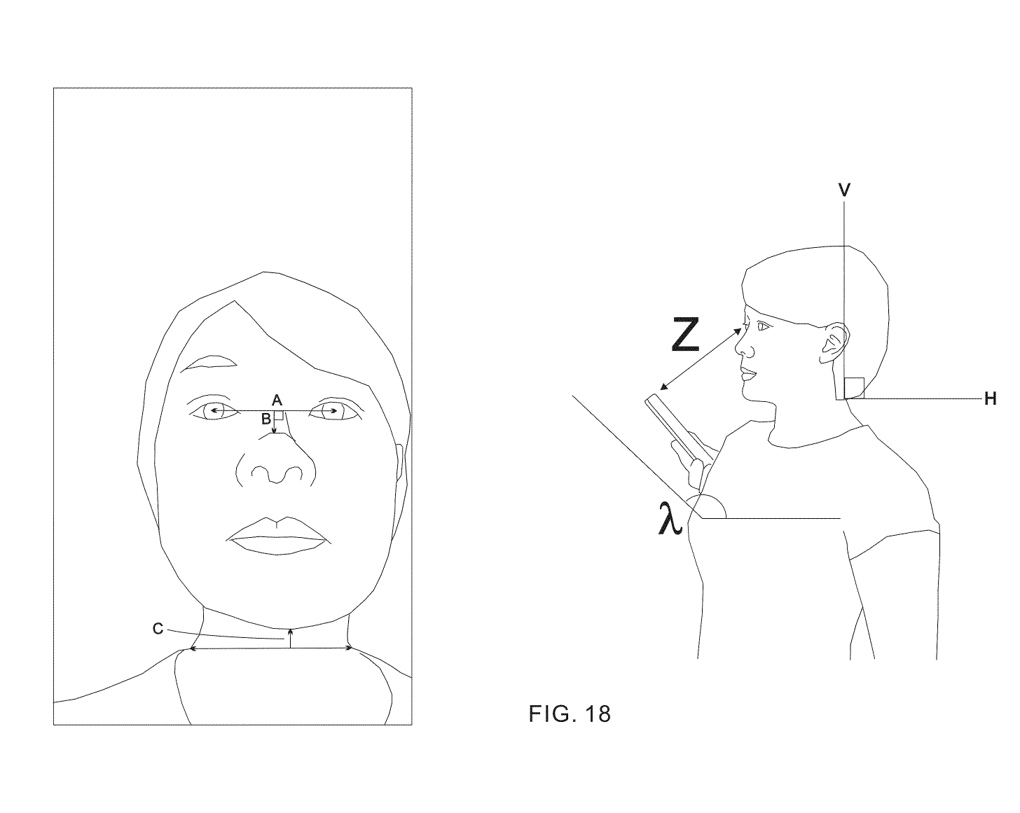

FIG. 18 illustrates another exemplary detection by the monitoring system. Left portion of FIG. 18 is a real time image captured during the detection. Right portion of FIG. 18 shows the posture assumed by the user during the real time detection. The scenario of FIG. 18 is most understandable with reference to that of FIG. 10 and FIG. 17. Compared to the posture assumed by the user in FIG. 17, the angle of inclination A of the smart device detected is even larger, i.e. λ>β>α. The detected characteristics together indicates that the smart device is positioned below the eye level and at an even closer distance to the user.

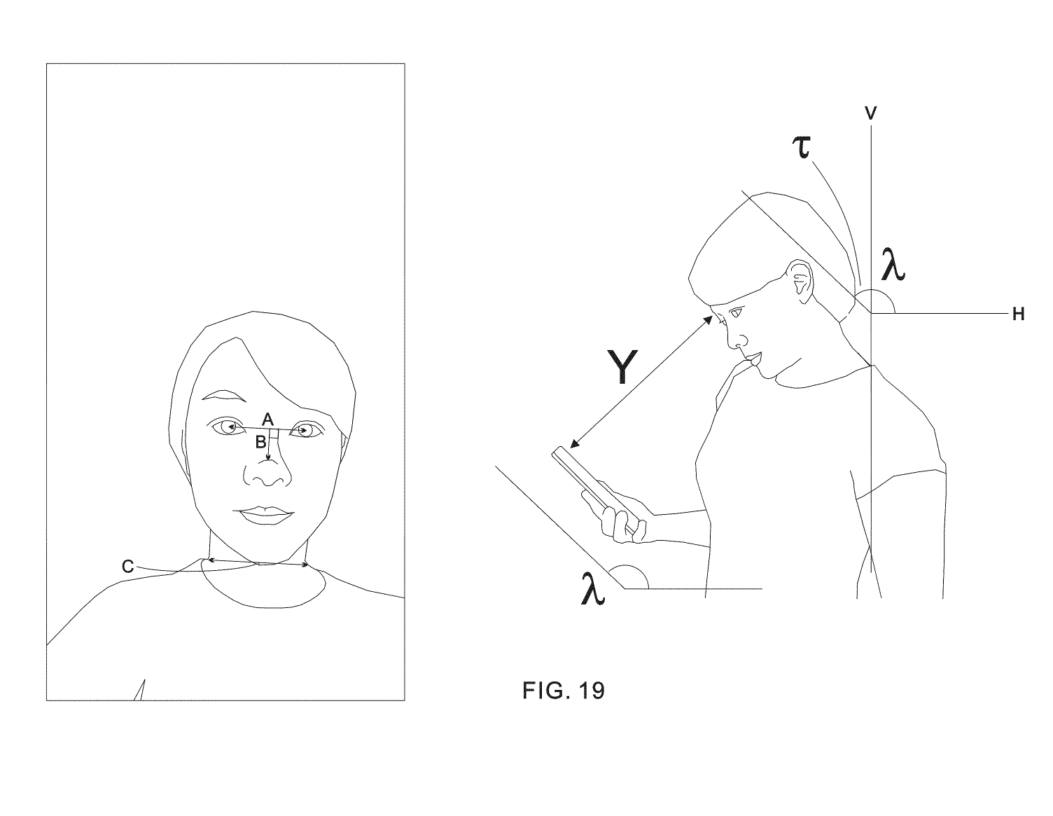

FIG. 19 illustrates another exemplary detection by the monitoring system. Left portion of FIG. 19 is a real time image captured during the detection. Right portion of FIG. 19 shows the posture assumed by the user during the real time detection. The scenario of FIG. 19 is most understandable with reference to that of FIG. 10 and FIG. 15. Compared with the detection of FIG. 10, the real time distance A, the real time distance B and the angle of inclination λ detected have increased, and the real time distance C has also increased from a negative value to about zero. The characteristics together indicate the particular posture of the real time posture of the user, i.e. the user is bending her head forward when viewing the smart device. The extent of bending of the user's neck is represented by the angle t between the vertical plane and the plane defined the user's neck having been bent forward.

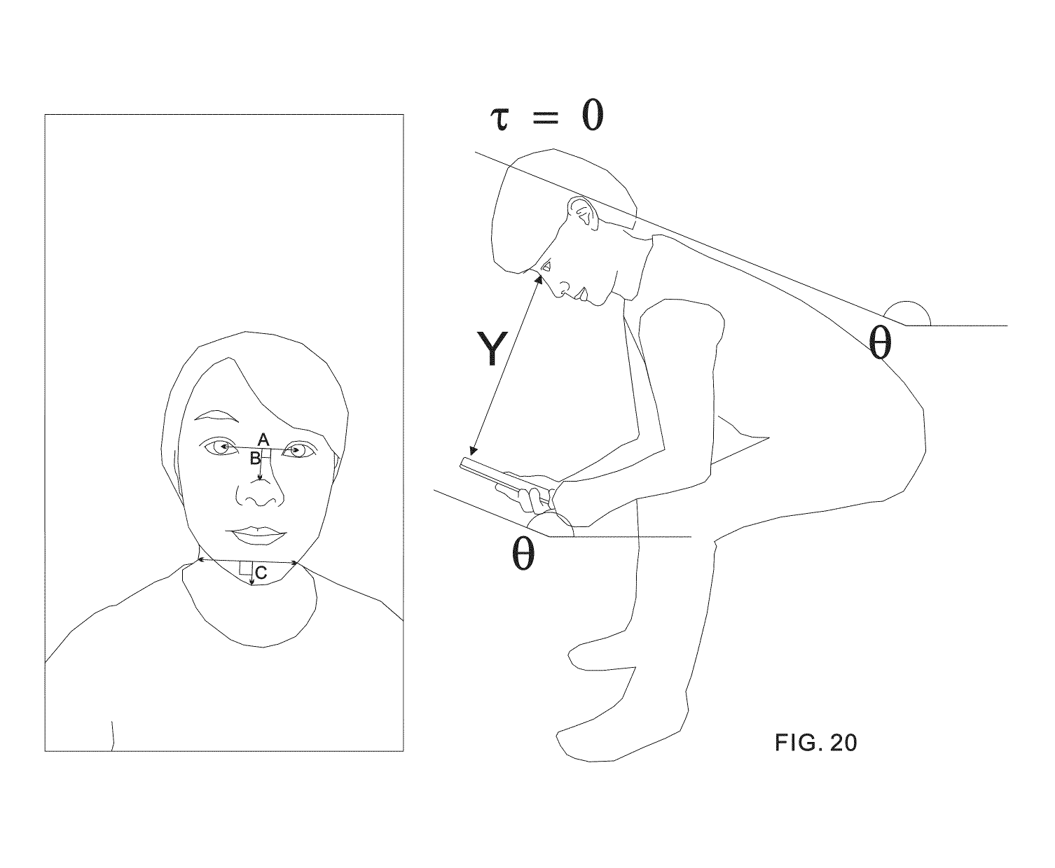

FIG. 20 illustrates another exemplary detection by the monitoring system. Left portion of FIG. 20 is a real time image captured during the detection. Right portion of FIG. 20 shows the posture assumed by the user during the real time detection. The scenario of FIG. 20 is most understandable with reference to that of FIG. 10 and FIG. 13. Compared with the detection of FIG. 10, the real time distance A, real time distance B and the angle of inclination θ all have increased. The real time distance C however has decreased. With date of these characteristics together, the monitoring system can determine that the user is using the smart device with her upper body bending forward.

It is to be understood that whether a real time characteristic is considered as staying within a threshold is a user pre-setable feature. For example, the user (or a guardian of the user) can pre-set in the monitoring system that the threshold of the value of real time viewing distance is, for example, 30% less than that of the recorded reference value X. Whenever the monitoring system extrapolates that the real time viewing distance 0.7X or less then the threshold is considered crossed.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples. For example, although the embodiments of the present invention are illustrated with reference to primarily mobile electronic or smart devices, a skilled person can envisage that the invention can equality applicable to other electronic devices such as desktop computers. Also, a skilled person in the art will be aware of the prior art which is not explained in the above for brevity purpose.

1. A system for monitoring habits of a registered user of an electronic device, comprising steps of:—
a) a detection module configured to generate data for use in extrapolating posture characteristics of the registered user during regular use of the electronic device, the posture characteristics including viewing distance between the registered user and the electronic device, extent of bending of the registered user's head when viewing the electronic device, and duration of time that the registered user has been viewing the electronic device;
b) a calculation module configured to utilize the data collected from the detection module and to extrapolate a particular posture assumed by the registered user;
c) a comparison module configured to match the particular posture in step b) against a number of postures predetermined as unacceptable postures and to generate an output instruction when a match is identified, information of the unacceptable postures being stored in the comparison module or elsewhere in the system; and
d) a warning module configured to, on receipt of the output instruction in step c), execute an alert action, the alert action either preset to the system or pre-selectable by the registered user or a guardian of the registered user.

2. A system as claimed in claim 1, comprising means for detecting angular position of the electronic device in relation to ground level.

3. A system as claimed in claim 2, wherein the detection means is an accelerometer.

4. A system as claimed in claim 2, wherein the detection module includes a proximity sensor for detecting the viewing distance.

5. A system as claimed in claim 2, wherein the detection module includes a camera.

6. A system as claimed in claim 1, wherein the posture characteristics further include extent of bending the registered user's back when viewing the electronic device.

7. A system as claimed in claim 5, comprising a presetting module for capturing and storing characteristics of the registered user in a presetting mode, the registered user characteristics including:—
a) a first horizontal distance being a first reference distance between two facial features of the registered user;
b) a first vertical distance being a second reference distance between two facial features of the registered user;
c) a second horizontal distance being a third reference distance between two non-facial features of the registered body below the registered user's head, the two non-facial features capturable by the camera's view during use of the electronic device; and
d) a second vertical distance being a fourth reference distance between the non-facial features and a facial feature of the registered user.

8. A system as claimed in claim 7, wherein the first reference distance is a distance between the center of the right eye and the center of the left eye of the registered user.

9. A system as claimed in claim 7, wherein the second reference distance is a distance between a center point between the right eye and the left eye of the registered user and the tip of the registered user's nose.

10. A system as claimed in claim 7, wherein the third reference distance is a distance across a base of the neck of the registered user.

11. A system as claimed in claim 7, wherein the fourth reference distance is a distance between the base of the neck and the lowest point of the registered user's chin.

12. A system as claimed in claim 7, wherein the detection module is configured to, in an exercise of real-time detection, detect and capture characteristics of:—
a) a first recorded distance between the two facial features of the first reference distance;
b) a second recorded distance between the two facial features of the second reference distance;
c) a third recorded distance between the two non-facial features of the third reference feature;
d) a fourth recorded distance between the non-facial features of the third reference feature and the facial feature of the fourth reference distance; and/or
e) an angle of inclination of the electronic device.

13. A system as claimed in claim 12, wherein the calculation module is configured to conduct extrapolation, based on a) the stored characteristics of the registered user obtained from the presetting module and b) the captured characteristics of the registered user during the real-time detection exercise, a particular posture assumed by the registered user in the real-time detection exercise.

14. A system as claimed in claim 13, wherein the comparison module is configured to, on receipt of data from the extrapolation indicative of the particular posture, determine whether during the real time detection:—
a) the viewing distance is shorter than a predetermined acceptable value;
b) the extent of bending of the head of the user is greater than a predetermined acceptable value;
c) the extent of bending of the back of the user is greater than a predetermined acceptable value; and/or
d) the duration of time the electronic device has been in use for longer than a predetermined allowable duration.

15. A system as claimed in claim 14, wherein the alert action is configured to include, select or selectable from a group including prompting a visual message on a screen of the electronic device, prompting an audio signal via a speaker of the electronic device, generating a vibration to the electronic device and turning off the electronic device.

16. A smart phone, a tablet or a computing device provided with a screen with which a user interacts, comprising a system as claimed in claim 1.

17. A method for monitoring habits of a registered user during use of an electronic device, comprising:—
a) providing a detection module configured to generate data usable for use in extrapolating posture characteristics of the registered user during regular use of the electronic device, the posture characteristics including viewing distance between the registered user and the electronic device, extent of bending of the registered user's head when viewing the electronic device, and duration of time of the registered user viewing the electronic device;
b) providing a calculation module configured to utilize the data collected from the detection module and to extrapolate a particular posture assumed by the registered user;
c) providing a comparison module configured to match the particular posture in step b) against a number of postures predetermined as unacceptable postures and to generate an output instruction when a match is identified, information of the unacceptable postures being stored in the comparison module or elsewhere in the system; and
d) providing a warning module configured to, on receipt of the output instruction in step c), execute an alert action, the alert action is either preset to the system or pre-selectable by the registered user or a guardian of the registered user.

18. A method as claimed in claim 17, comprising providing means for detecting angular position of the electronic device in relation to a ground level, wherein the detection means is a gyroscope and the detection module includes a camera.

19. A method as claimed in claim 18, wherein the posture characteristics further include extent of bending the registered user's back when viewing the electronic device.

20. A method as claimed in claim 19, comprising providing a presetting module for capturing and storing characteristics of the registered user in a presetting mode, the registered user characteristics including at least some of:—
a) a first horizontal distance being a first reference distance between two facial features of the registered user;
b) a first vertical distance being a second reference distance between two facial features of the registered user;
c) a second horizontal distance being a third reference distance between two non-facial features of the registered body below the registered user's head, the two non-facial features capturable by the camera's view during use of the electronic device; and
d) a second vertical distance being a fourth reference distance between the non-facial features and a facial feature of the registered user.
